(19) United States
(12) Patent Application Publication
(10) Pub. No.: US 2003/0113507 A1
(43) Pub. Date: Jun. 19, 2003

(54) Wrapped absorbent structure

(76) Inventors: Michael John Niemeyer, Appleton, WI (US); Kent Allan Franklin, Appleton, WI (US); Robin Kurt Nason, Oshkosh, WI (US); Susan Elaine Shawver, Roswell, GA (US); Paul Windsor Estey, Cumming, GA (US); Larry N. Barnett, Kingsport, TN (US)

Correspondence Address: PAULEY PETERSEN KINNE & ERICKSON, 2800 WEST HIGGINS ROAD, SUITE 365, HOFFMAN ESTATES, IL, 60195, US

(21) Appl. No.: 10/025,214

(22) Filed: Dec. 18, 2001

(51) Int. Cl. B32B 5/16; B32B 3/14; D04H 1/00

(52) U.S. Cl. 428/77; 442/415; 442/416; 442/417; 2/67; 604/365; 604/366; 604/367; 604/368; 604/369; 604/374; 604/378; 604/379; 604/385.25; 604/385.3

(57) ABSTRACT

A wrapped absorbent structure that includes two or more absorbent materials to maximize the absorbent functionality of the structure without sacrificing integrity. The structure includes an absorbent core surrounded by an absorbent wrap. The absorbent core is primarily intended to provide absorbent capacity while the absorbent wrap is used to maintain wetness integrity, although the absorbent wrap also provides a considerable amount of absorbent capacity. The absorbent structure is particularly suitable for use in absorbent swimwear.

### BACKGROUND OF THE INVENTION

This invention is directed to a wrapped absorbent structure that includes two or more absorbent materials to maximize the absorbent functionality of the structure without sacrificing integrity.

Absorbent structures are typically present within absorbent articles to provide absorbent capacity. In order to maintain absorbent capacity, the absorbent structure must also be able to provide structural integrity when the absorbent structure becomes wet. The balance between absorbent capacity and structural integrity is particularly crucial in absorbent swimwear garments. Absorbent swimwear garments are designed to absorb urinary insults prior to swimming as well as to prevent solid waste matter from entering into the swim water during swimming and other water play. If the absorbent capacity of the absorbent structure is too low, the swimwear will not be able to contain the insult and the garment will be prone to leakage before swimming. Conversely, if the structural integrity is insufficient, the absorbent material will fall apart, in which case the swimwear will again be prone to leakage as well as poor fit and appearance when wet.

The absorbent structure may include binder materials within an absorbent material to provide structural integrity, but the binder materials minimize the absorbent capacity of the absorbent material by taking up volume within the absorbent material. Alternatively, the absorbent structure can include an absorbent core, providing absorbent capacity, and binder material wrapped around the absorbent core to provide structural integrity. However, the binder material may again hinder the absorbent capacity of the structure by blocking access of liquid to the absorbent material. For example, meltblown polymer wraps provide sufficient wet strength, but do not provide notable absorbent capacity to the structure. On the other hand, tissue wraps provide some absorbent capacity, but they do not provide the wet strength required to withstand water play conditions.

There is a need or desire for an absorbent structure that provides maximum absorbent functionality without sacrificing structural integrity.

There is a further need or desire for an absorbent swimwear garment having an absorbent structure with an absorbent capacity sufficient to handle pre-swim insults and enough structural integrity to withstand water play activity.

### SUMMARY OF THE INVENTION

In response to the discussed difficulties and problems encountered in the prior art, a new absorbent structure has been discovered.

The present invention is directed to an absorbent structure including two or more absorbent materials to maximize the absorbent functionality of the structure without sacrificing structural integrity. The absorbent structure can be used in any personal care garment, such as a diaper, a training pant, a feminine hygiene product, or an incontinence product, and is particularly suitable for use in absorbent swimwear.

The absorbent structure includes an absorbent core to provide absorbent capacity, and a stabilized absorbent wrap fully surrounding the absorbent core thereby providing structural integrity. The absorbent core contains a minimal amount of binder material, or no binder material, to maximize absorbent capacity while the wrap material contains a significant amount of binder material to provide sufficient wet integrity to the structure while providing additional absorbent capacity. Since the wrap is absorbent, the wrap does not hinder the absorbent capacity of the absorbent core, as a nonabsorbent wrap would.

The absorbent core is lightly stabilized to non-stabilized, including between 0% and about 10% binder material. The absorbent core can include an air-formed absorbent material, such as air-formed pulp fluff; a mixture of pulp fluff and superabsorbent; a mixture of pulp fluff and a polymer; a mixture of pulp fluff and hot melt spray adhesive; a mixture of pulp fluff and thermoplastic binder fibers; a mixture of pulp fluff, superabsorbent and binder fibers; coform; or combinations of any of the preceding. Alternatively, the absorbent core can include an elastomeric superabsorbent/meltblown mixture, possibly with a small amount of pulp fluff, and a surfactant may be included as well. Superabsorbent content in the absorbent core can vary, but in particular embodiments ranges from 0% to about 15%, with around 0% typically included in absorbent swimwear and generally a higher percentage included in non-swimwear applications. Superabsorbent materials can include particulates, fibers, films, foams, non-ionic superabsorbents, and/or polyacrylate superabsorbents.

The absorbent wrap can contain a significant amount of binder material. Suitable binder materials may include meltblown polymers, thermoplastic binder fibers, and liquid-sprayable binding agents. For example, the absorbent wrap may include a coform material of a pulp and a meltblown polymer mixture. Because of the binder material, the wrap has low liquid acquisition and transport capabilities. Nevertheless, the absorbent wrap does include considerable absorbent capacity. In fact, the absorbent wrap provides a notable amount of the total absorbent capacity of the structure, for example, at least 20%, or between 30% and 60%. The absorbent structure suitably has an absorbent wrap to inner core absorbency ratio of at least 0.2, or at least 0.3, or at least 0.4.

As far as the physical structure of the absorbent structure, the absorbent wrap fully surrounds the absorbent core. Suitably, the absorbent wrap overlaps itself, at least along two opposing edges, with the wrap situated as close as possible to the side margins of the absorbent core to inhibit clumping or bunching of the absorbent core, especially when the absorbent structure is being worn by an active user, such as during water play in the case of absorbent swimwear. End regions of the wrap do not necessarily have to include an overlap, or fold onto itself, as long as the end regions are tacked to another stable piece of material in the garment, such as an outer cover, or the end regions may be tacked to themselves. If the absorbent core is not tightly wrapped, there may be a tendency for the materials to re-distribute and clump within the wrap when the absorbent structure is saturated. Furthermore, the absorbent core can be zoned to provide added capacity to a central portion of the structure, or the absorbent core can be segmented to provide better containment of non-stabilized absorbent material.

With the foregoing in mind, particular embodiments of the invention provide an absorbent structure that provides maximum absorbent functionality without sacrificing structural integrity.

### BRIEF DESCRIPTION OF THE DRAWINGS

FIG. 1 is a perspective view of an absorbent structure of the invention with end regions of the absorbent wrap in a partially folded state;

FIG. 2 is a perspective view of the absorbent structure of FIG. 1 with the absorbent wrap in a fully folded state;

FIG. 3 is a cross-sectional view of the absorbent structure of FIG. 2, taken along line 3-3;

FIG. 4 is a cross-sectional view of one embodiment of the absorbent structure of FIG. 2, taken along line 4-4;

FIG. 5 is a cross-sectional view of another embodiment of the absorbent structure of FIG. 2, taken along line 4-4;

FIG. 6 is a front perspective view of an absorbent swim pant including an absorbent structure of the invention;

FIG. 7 is a plan view of an absorbent swim pant in a partially disassembled, stretched flat state, and showing the surface of the swim pant that faces the wearer when the swim pant is worn, and with portions cut away to show the underlying features; and

FIG. 8 is an illustration of equipment for determining the liquid saturated retention capacity of an absorbent structure.

### DEFINITIONS

Within the context of this specification, each term or phrase below will include the following meaning or meanings.

“Air-formed” refers to a mat comprising cellulosic fibers such as those from fluff pulp that have been separated, such as by a hammermilling process, and then deposited on a porous surface without a substantial quantity of binder fibers present.

“Coform” refers to a material which is produced by combining air-entrained dry, dispersed cellulosic fibers with meltblown synthetic polymer fibers while the polymer fibers are still tacky. Coform materials and methods of making coform materials are described, for example, in U.S. Pat. No. 4,100,324, issued to Anderson et al., and in U.S. Pat. No. 5,508,102, issued to Georger et al., both of which are hereby incorporated by reference.

“Elastomeric” and “elastic” refer to that property of a material or composite by virtue of which it tends to recover its original size and shape after removal of a force causing a deformation. Under conditions of use, it is generally preferred that the elastomeric material or composite be capable of being elongated by at least 50 percent, more preferably by at least 300 percent, of its relaxed length and recover, upon release of an applied force, at least 50 percent of its elongation. A hypothetical example which will satisfy this definition of an elastomeric material would be a one (1) inch sample of a material which is elongatable to at least 1.5 inches (50% elongation), preferably 4 inches (300% elongation) and which, upon being elongated to 1.5 inches and released, will recover to a length of not more than 1.25 inches, or upon being elongated to 4 inches and released, will recover to a length of not more than 2.5 inches.

“Film” refers to a thermoplastic film made using a film extrusion process, such as a cast film or blown film extrusion process. The term includes apertured films, slit films, and other porous films which constitute liquid transfer films, as well as films which do not transfer liquid.

“Meltblown fiber” means fibers formed by extruding a molten thermoplastic material through a plurality of fine, usually circular, die capillaries as molten threads or filaments into converging high velocity heated gas (e.g., air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed for example, in U.S. Pat. No. 3,849,241 to Butin et al. Meltblown fibers are microfibers which may be continuous or discontinuous, are generally smaller than about 0.6 denier, and are generally self bonding when deposited onto a collecting surface. Meltblown fibers used in the present invention are preferably substantially continuous in length.

“Nonwoven” and “nonwoven web” refer to materials and webs of material which are formed without the aid of a textile weaving or knitting process.

“Polymers” include, but are not limited to, homopolymers, copolymers, such as for example, block, graft, random and alternating copolymers, terpolymers, etc. and blends and modifications thereof Furthermore, unless otherwise specifically limited, the term “polymer” shall include all possible geometrical configurations of the material. These configurations include, but are not limited to isotactic, syndiotactic and atactic symmetries.

“Pulp fluff” or “fluff pulp” refers to a material made up of cellulose fibers. The fibers can be either natural or synthetic, or a combination thereof. The material is typically lightweight and has absorbent properties. “Superabsorbent” or “superabsorbent material” refers to a water-swellable, water-insoluble organic or inorganic material capable, under the most favorable conditions, of absorbing at least about 15 times its weight and, more desirably, at least about 30 times its weight in an aqueous solution containing 0.9 weight percent sodium chloride. The superabsorbent materials can be natural, synthetic and modified natural polymers and materials. In addition, the superabsorbent materials can be inorganic materials, such as silica gels, or organic compounds such as cross-linked polymers.

“Thermoplastic” describes a material that softens when exposed to heat and which substantially returns to a nonsoftened condition when cooled to room temperature.

These terms may be defined with additional language in the remaining portions of the specification.

### DETAILED DESCRIPTION OF THE PRESENTLY PREFERRED EMBODIMENTS

The present invention is directed to an absorbent structure including an absorbent wrap surrounding an absorbent core, thereby creating an absorbent structure having absorbent capacity as well as structural integrity. The absorbent structure can be used in any personal care garment, such as a diaper, a training pant, a feminine hygiene product, or an incontinence product, and is particularly suitable for use in absorbent swimwear.

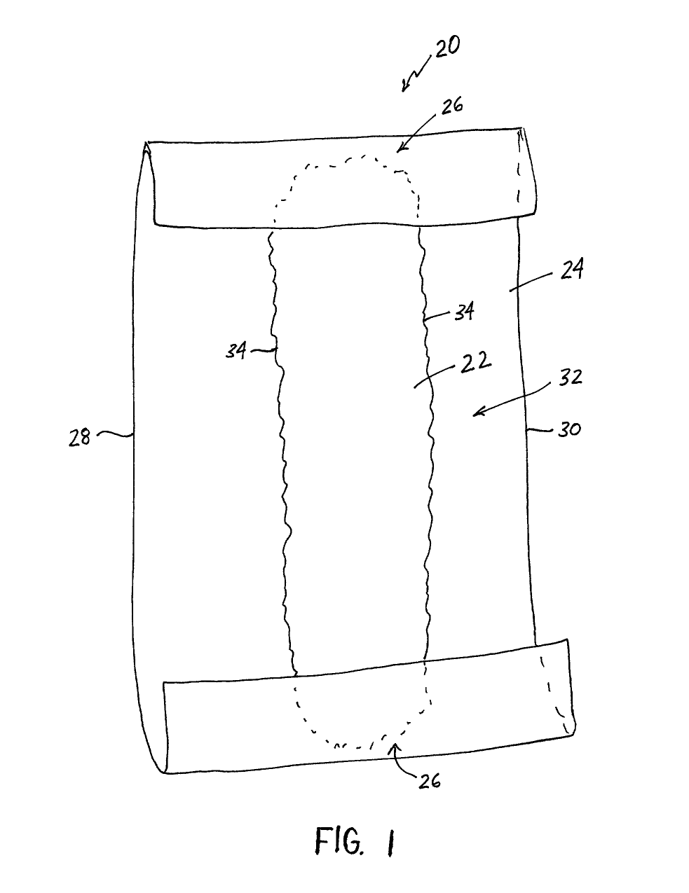

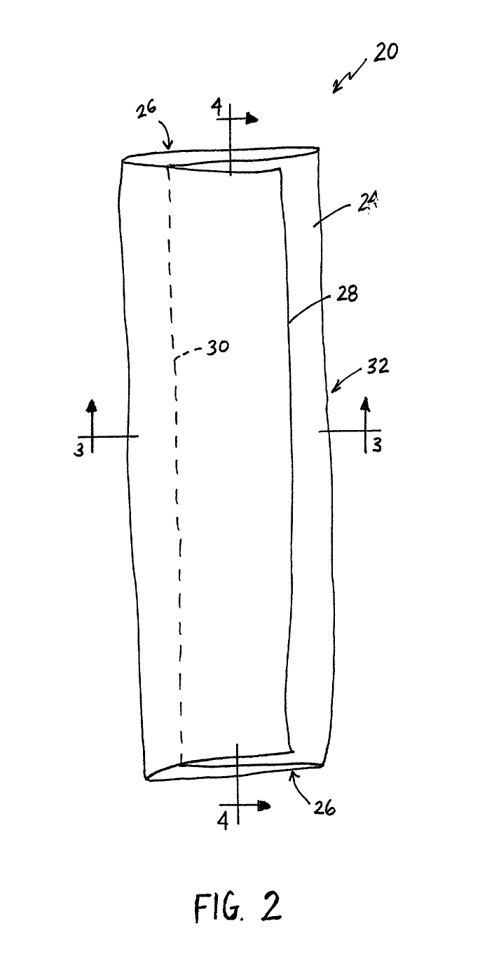

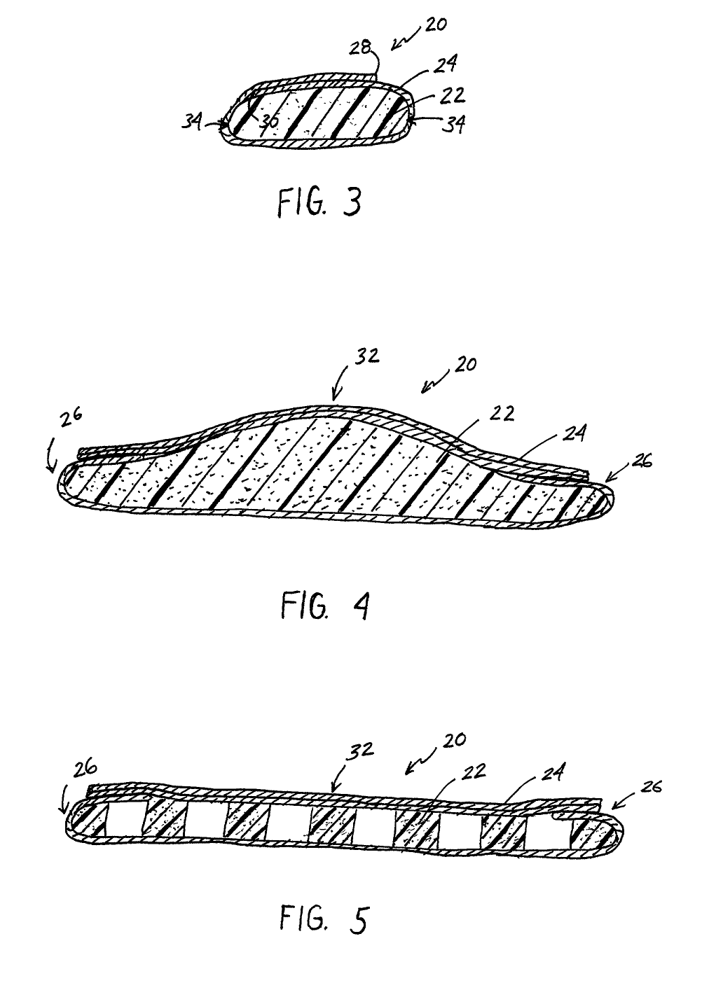

As shown in FIGS. 1-3, the absorbent structure 20 includes a lightly-stabilized or non-stabilized absorbent core 22 encompassed by a stabilized absorbent wrap 24. FIG. 1 shows the absorbent wrap 24 in a partially folded position, with the wrap 24 folded at opposite end regions 26 of the structure, and the core 22 exposed. FIG. 2 shows the wrap 24 in a fully folded position, fully surrounding the absorbent core 22 (shown in FIGS. 3-5). A first longitudinal edge 28 of the wrap suitably overlaps a second longitudinal edge 30 of the wrap, as illustrated in FIG. 3 which is a cross-section of FIG. 2. The wrap 24 can be folded around the core 22 in a manner similar to folding a burrito, recognizing as would all connoisseurs of fast Mexican food that there are many suitable alternative ways to fold a burrito. For example, the wrap 24 need not be folded at the opposite end regions 26, but may instead be folded only manner shown in FIG. 2, with the first longitudinal edge 28 overlapping the second longitudinal edge 30, as long as the end regions 26 are tacked to another stable piece of material in the garment, such as an outer cover, or the end regions 26 may be tacked to themselves.

Most of the absorbent capacity of the absorbent structure 20 is present in the absorbent core 22, although the absorbent wrap 24 provides some absorbent capacity as well. The absorbent wrap 24 suitably provides at least 20% of a total absorbent capacity of the absorbent structure 20, or at least 25%, or at least 30% and up to about 60% of the total absorbent capacity of the absorbent structure. A ratio of the absorbent capacity of the absorbent wrap 24 to the absorbent capacity of the absorbent core 22 is at least 0.2, or at least 0.3, or at least 0.4. The term “absorbent capacity,” as used herein, refers to saturated capacity as measured according to the test method provided below.

The absorbent core 22 suitably includes an air-formed absorbent material containing an amount of binder material, suitably between 0% and about 10% binder material by weight of the absorbent core, to maximize absorbent capacity. The absorbent core 22 can include air-formed pulp fluff; a mixture of pulp fluff and superabsorbent; a mixture of pulp fluff and a polymer; a mixture of pulp fluff and hot melt spray adhesive; a mixture of pulp fluff and thermoplastic binder fibers; a mixture of pulp fluff, superabsorbent, and binder fibers; coform; or combinations of any of these materials. One example of a suitable pulp fluff is identified with the trade designation CR1654, available from U.S. Alliance, Childersburg, Ala., U.S.A., and is a bleached, highly absorbent sulfate wood pulp containing primarily soft wood fibers.

Another example of suitable material for the absorbent core 22 includes a mixture of superabsorbent material and meltblown fibers. This particular combination of materials provides considerable absorbent capacity without considerable bulk. The superabsorbent material and meltblown fibers can be present in the form of a coform material. Furthermore, the meltblown fibers can be made of an elastomeric material. Examples include, but are not limited to, polyurethane and commercially available products such as styrenic block copolymers, available from Kraton Polymers located in Belpre, Ohio, U.S.A., under the trade name KRATON, and polyether amides, available from Ato Chemical Company of Wauwatosa, Wis., U.S.A., under the trade name PEBAX. Other suitable elastomeric materials include polyolefin-based elastomers, such as single-site catalyzed polyethylene, and thermoplastic polyurethane. In addition to the superabsorbent material and meltblown fibers, the absorbent core 22 may include an amount of pulp fluff, for example between about 30% and about 55%, or between about 35% and about 50% by weight of the absorbent core. Pulp fluff contributes to fluid handling capabilities of the absorbent core 22. The absorbent core 22 may also include a surfactant to increase the hydrophilicity of the meltblown fibers. A couple of examples of suitable surfactants are commercially available from Uniqema in Wilmington, Del., under the trade designation AHCOVEL, and from Henkel KGAA Corporation in Dusseldorf, Germany, under the trade designation GLUCOPON 220.

Superabsorbent content in the absorbent core 22 suitably ranges from 0% to about 15%. The superabsorbent materials can include particulates, fibers, films, foams, non-ionic superabsorbents, and/or polyacrylate superabsorbents, for example. The superabsorbent materials can be selected from natural, synthetic, and modified natural polymers and materials. The superabsorbent materials can be inorganic materials, such as silica gels, or organic compounds, such as crosslinked polymers. Suitable superabsorbent materials are available from various commercial vendors, such as Dow Chemical Company located in Midland, Mich., U.S.A., and Stockhausen GmbH & Co. KG, D-47805 Krefeld, Federal Republic of Germany. Typically, a superabsorbent material is capable of absorbing at least about 15 times its weight in water, and desirably is capable of absorbing more than about 25 times its weight in water.

The absorbent wrap 24 material contains a significant amount of binder material to provide sufficient wet integrity to the structure and also contains absorbent material to provide additional absorbent capacity to the absorbent structure 20. The binder material may include meltblown polymer, thermoplastic binder fibers, and/or liquid-sprayable binding agents. Because of the binder material, the absorbent wrap 24 has low liquid acquisition and transport capabilities, but the presence of absorbent material within the absorbent wrap 24 provides at least some absorbent capacity. Besides the binder material, the remainder of the absorbent wrap 24 may include a nonwoven web, or coform material of a pulp fluff and meltblown polymer mixture, or any other suitable absorbent materials.

Two classes of binder materials can be considered: thermoplastic solid materials (particles or fibers), and liquids (for example, resins or solutions) that can be cured or set by application of heat or other energy sources to provide dry, water-resistant bonds between fibers. The binder material can comprise about 35% or more of the dry mass of the absorbent wrap 24, such as from about 5% to 50%, or from 15% to 45%, or from 20% to 40%.

For solid binder materials, any known thermoplastic material can be used as a binder, provided that the material can be fused at a temperature that does not destroy or render unsuitable the absorbent wrap 24 itself. A thermoplastic binder upon activation by heat becomes soft but reverts to its normal solid state upon cooling. Representative of such thermoplastic binder materials are polypropylenes, polyethylenes, polycarbonates, polyvinyl chloride, polyesters, polystyrenes, acrylics and the like. The binder material may be hydrophobic or hydrophilic. Hydrophilic fibers can be inherently hydrophilic or can be a synthetic hydrophobic fiber that has been treated with a hydrophilic coating or treatment. Examples of hydrophilic binder fibers are given in U.S. Pat. No. 5,849,000 issued to Anjur et al., herein incorporated by reference.

The binder material can be monocomponent fibers or bicomponent polymer fibers such as sheath/core fibers or side-by-side bicomponent fiber, having a first component with a lower melting point than the second component, such that upon heating to about the melting point of the first component, the first component can fuse and bond to nearby cellulosic fibers while the second component can maintain the integrity of the binder fiber. Examples include DANAKLON bicomponent fibers of Hercules, Inc. (Wilmington, Del.); or PET (poly(ethylene terephthalate)) core fibers and an activated co-polyethylene sheath, such as CELBOND fibers produced by KoSA Inc. (formerly Trevira Inc. and formerly Hoechst-Celanese), Salisbury, N.C., under the designation T-255 and T-256. Other useful binder fibers include copolyester fibers or materials produced by ES FiberVisions Inc. In addition to sheath/core fibers, components of a binder fiber having a plurality of polymers may be arranged in an eccentric sheath/core arrangement, a side-by-side arrangement, a pie arrangement or an “islands-in-the-sea” arrangement, or in a blend. Conjugate fibers are taught in U.S. Pat. No. 5,108,820 issued to Kaneko et al., U.S. Pat. No. 5,336,552 issued to Strack et al., and U.S. Pat. No. 5,382,400 issued to Pike et al. For two-component fibers, the polymers may be present in ratios of 75/25, 50/50, 25/75 or any other desired ratios. The fibers may also have shapes such as those described in U.S. Pat. Nos., 5,277,976; 5,069,970; and 5,057,368; each hereby incorporated by reference in their entirety, which describe fibers with unconventional shapes.

Monocomponent fibers can include, by way of example, polyethylene microfibers marketed as PULPEX fibers by Hercules, Inc. (Wilmington, Del.) or Eastman's KODEL 410 binder fiber. This fiber requires a minimum temperature of about 132° Celsius for good bonding. CoPET B from Eastman Chemical Company is another commercially available binder material with an activation temperature of about 110° Celsius or higher. (This material can also be used as a sheath. For example, a useful bicomponent fiber is a coextruded sheath/core bicomponent with 35% CoPET B and a 65% PET core.)

Fibrous binder material can have a weight-averaged fiber length of about 8 centimeters (cm) or less, specifically from about 0.2 cm to 5 cm, more specifically from 0.3 cm to 3 cm, more specifically still from 0.3 cm to 2 cm, and most specifically from 0.4 cm to 1 cm.

The binder material can also be a microwave-sensitive material having a high dielectric loss constant (for example, from about 1 to 1,000 measured at a frequency of 1 kHz) such that the binder material is heated more than any cellulosic fibers in the absorbent wrap when microwave energy is applied. (Cellulose can have a loss factor on the order of about 0.06 at 1 kHz.) Exemplary materials include polyamide or polyvinyl methyl based hot melt adhesives and other thermoplastics known in the art. Polyether block amides, polyvinyl chloride (PVC), and related compounds also have high loss factors. The material can have a loss factor much greater than that of cellulose.

Binder materials can also be applied as liquid resins, slurries, colloidal suspensions, or solutions that become rigid or crosslinked upon application of energy (for example, microwave energy, heat, ultraviolet radiation, and the like).

Various types of thermosetting binders are known to the art such as amino resins, epoxides, silicones, and the like, as well as elastomeric latex emulsions. Representative thermosetting binder materials which are adapted for application in the form of a liquid dispersion include copolymers of ethylene and acrylic acid, vinyl acetate-ethylene copolymers, acrylonitrile-butadiene copolymers, vinylchloride polymers, vinylidene chloride polymers, curable acrylic latex compositions, and the like.

Water-soluble, non-colloidal, cationic, thermosetting binders suitable for use with cellulosic fibers are disclosed in U.S. Pat. No. 4,617,124 issued to Pall et al., herein incorporated by reference, where epoxide-based versions are said to be preferred, including both polyamido/polyaminoepichlorohydrin resins and polyamine-epichlorohydrin resins, such as KYMENE 557 and the POLYCUP series of resins manufactured by Hercules Incorporated (Wilmington, Del.). Related materials can be prepared by reacting epichlorohydrin with condensation products of polyalkylene polyamides and ethylene dichloride. Compositions of this type are disclosed in U.S. Pat. No. 3,855,158 and are exemplified by SANTORES 31, a product of Monsanto Inc. Another form of this particular type of binder resin is prepared by the reaction of epichlorohydrin with polydiallyl methyl amine to produce an epoxide functional quaternary ammonium resin. Compositions of this kind are disclosed in U.S. Pat. No. 3,700,623 and are exemplified by Resin R4308, a product of Hercules Incorporated. The disclosures of U.S. Pat. Nos. 3,855,158 and 3,700,623 are incorporated herein by reference.

The absorbent structure 20 may include the absorbent core 22 as a uniform layer wrapped within the absorbent wrap 24, or alternatively, the absorbent core 22 may be zoned for greater absorbent capacity in a central portion 32 of the absorbent core 22 and lower absorbent capacity in the end regions 26 of the absorbent core 22, as shown in FIG. 4 which is a cross-sectional view of one embodiment of FIG. 2. As another alternative, the absorbent core 22 may be segmented, or split into multiple sections, within the absorbent wrap 24 to provide better containment of non-stabilized absorbent material, as shown in FIG. 5 which is a cross-sectional view of another embodiment of FIG. 2. In any case, the absorbent wrap 24 is suitably positioned as close as possible to side margin 34 of the absorbent core 22 to inhibit clumping or bunching of the absorbent core 22, particularly during water play in the case of swimwear including the absorbent structure 20. If the absorbent core 22 is not tightly wrapped, there may be a tendency for the absorbent core materials to re-distribute and clump within the absorbent wrap 24 when the absorbent structure 20 reaches a saturated state.

Another approach to providing stabilization in the absorbent structure 20 includes embossing the absorbent structure with various patterns. Embossing can improve the integrity of the structure.

As mentioned, the absorbent structure 20 is particularly suitable for use in absorbent swimwear garments. The combination of the lightly- to non-stabilized absorbent core 22 having little or no binder material and the stabilized absorbent wrap 24 having a substantial amount of binder material maximizes the absorbent functionality of the pant without sacrificing water play integrity. More particularly, using the absorbent structure 20 of the present invention in an absorbent swimwear garment can reduce pre-swim leakage as a result of the substantial absorbent capacity of the absorbent structure, and loss of superabsorbent material during swimming or other water play should be minimal because the superabsorbent material in the absorbent core is fully contained within the high-integrity absorbent wrap structure.

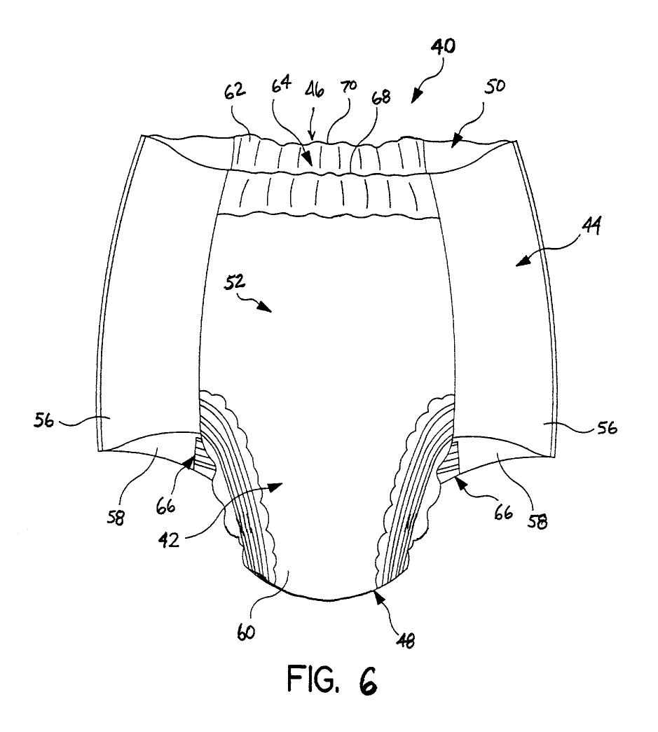

Referring to FIG. 6, an absorbent swimpant 40 is illustrated. The swimpant 40 includes an absorbent chassis 42. The absorbent chassis 42 defines a front region 44, a back region 46, a crotch region 48 interconnecting the front and back regions, an inner surface 50 which is configured to contact the wearer, and an outer surface 52 opposite the inner surface which is configured to contact a pool or lake environment.

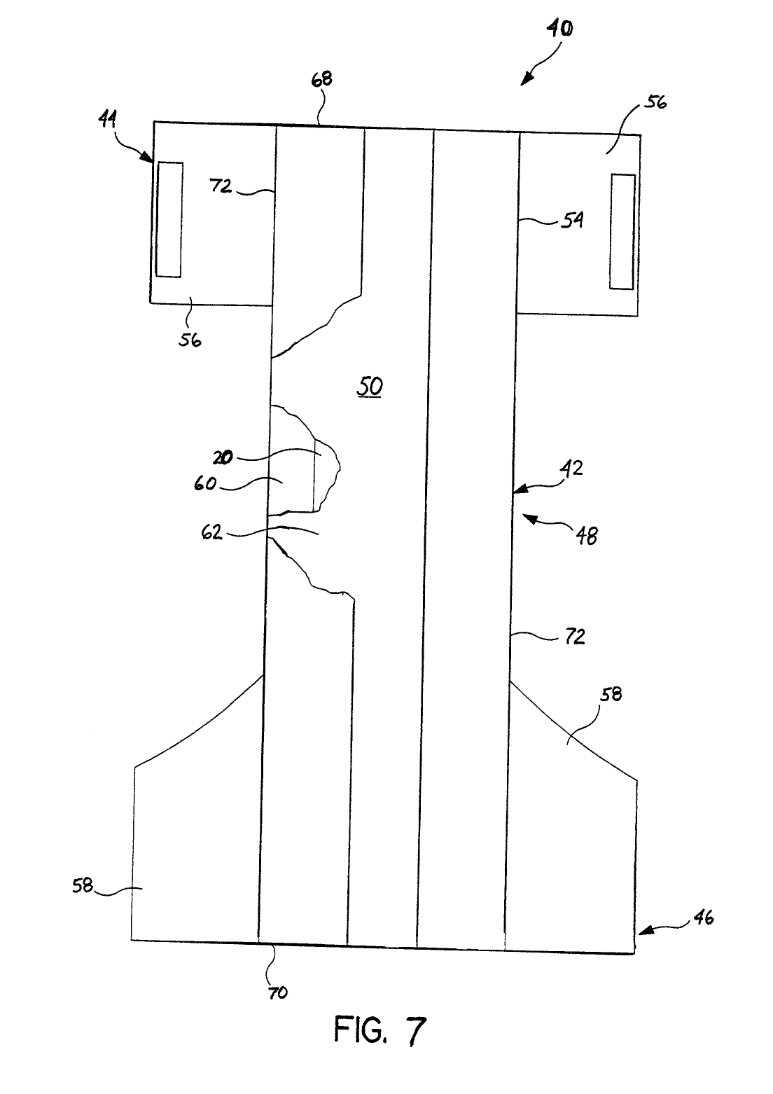

Referring to FIG. 7, the swimpant 40 is shown in a partially disassembled, stretched flat state, showing the inner surface 50 which faces the wearer when the garment is worn. The chassis 42 includes a somewhat rectangular composite structure 54, a pair of transversely opposed front side panels 56, and a pair of transversely opposed back side panels 58. The composite structure 54 and side panels 56, 58 may be integrally formed, as shown in FIG. 6, or may include two or more separate elements, as shown in FIG. 7.

The illustrated composite structure 54 includes an outer cover 60, a body side liner 62 which is connected to the outer cover 60 in a superposed relation, and the absorbent structure 20 can be located between the outer cover 60 and the body side liner 62.

As shown in the swimpant 40 in FIG. 6, the front and back regions 44, 46 together define a three-dimensional pant configuration having a waist opening 64 and a pair of leg openings 66. Front and back waist edges 68, 70 of the absorbent chassis 42 are configured to encircle the waist of the wearer when worn and provide the waist opening 64 which defines a waist perimeter dimension. Portions of transversely opposed side edges 72 (FIG. 7) in the crotch region 48 generally define the leg openings 66. The front region 44 includes the portion of the swimpant 40 which, when worn, is positioned on the front of the wearer while the back region 46 includes the portion of the swimpant 40 which, when worn, is positioned on the back of the wearer. The crotch region 48 of the swimpant 40 includes the portion of the swimpant 40 which, when worn, is positioned between the legs of the wearer and covers the lower torso of the wearer.

The absorbent structure 20, positioned between the outer cover 60 and the body side liner 62, is generally conformable, non-irritating to the child's skin, and capable of absorbing and retaining liquids and certain body wastes. The absorbent structure 20 can be manufactured in a wide variety of sizes and shapes.

As described herein, the absorbent structure 20 of the invention provides high absorbent capacity while maintaining structural integrity, which renders the absorbent structure particularly suitable for use in absorbent swimwear. When used in absorbent swimwear, the absorbent structure 20 provides sufficient absorbent capacity to prevent pre-swim leakage and has enough structural integrity to withstand swimming or other water play.

### Liquid Saturated Retention Capacity Test Procedure

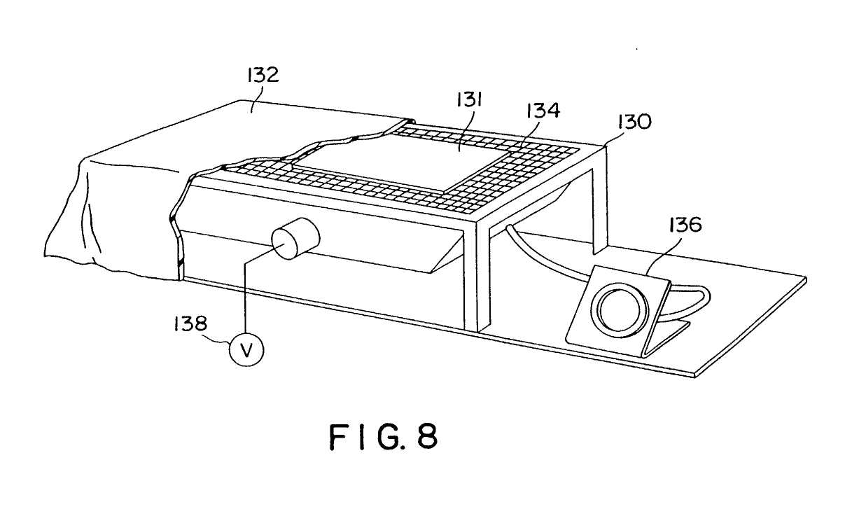

The liquid saturated retention capacity is determined as follows. The material to be tested, having a moisture content of less than about 7 weight percent, is weighed and submerged in an excess quantity of a 0.9 weight percent aqueous saline solution at room temperature (about 23 degrees Celsius). The material to be tested is allowed to remain submerged for about 20 minutes. After the 20 minute submerging, the material is removed and, referring to FIG. 8, placed on a TEFLON™ coated fiberglass screen 134 having 0.25 inch (0.6 cm) openings (commercially available from Taconic Plastics Inc., Petersburg, N.Y.) which, in turn, is placed on a vacuum box 130 and covered with a flexible rubber dam material 132. A vacuum of about 0.5 pound per square inch (about 3.5 kilopascals) is drawn on the vacuum box for a period of about 5 minutes with the use of, for example, a vacuum gauge 136 and a vacuum pump 138. The material 131 being tested is then removed from the screen and weighed. The amount of liquid retained by the material being tested is determined by subtracting the dry weight of the material from the wet weight of the material (after application of the vacuum), and is reported as the absolute liquid saturated retention capacity in grams of liquid retained. If desired, the weight of liquid retained may be converted to liquid volume by using the density of the test liquid, and is reported as the liquid saturated retention capacity in milliliters of liquid retained. For relative comparisons, this absolute liquid saturated retention capacity value can be divided by the dry weight of the material 131 to give the specific liquid saturated retention capacity in grams of liquid retained per gram of tested material. If material, such as hydrogel-forming polymeric material or fiber, is drawn through the fiberglass screen while on the vacuum box, a screen having smaller openings should be used. Alternatively, a piece of tea bag or similar material can be placed between the material and the screen and the final value adjusted for the liquid retained by the tea bag or similar material.

It will be appreciated that details of the foregoing embodiments, given for purposes of illustration, are not to be construed as limiting the scope of this invention. Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention, which is defined in the following claims and all equivalents thereto. Further, it is recognized that many embodiments may be conceived that do not achieve all of the advantages of some embodiments, particularly of the preferred embodiments, yet the absence of a particular advantage shall not be construed to necessarily mean that such an embodiment is outside the scope of the present invention.

We claim:

1. An absorbent structure, comprising:
an absorbent core; and
an absorbent wrap including a binder material, the absorbent wrap fully surrounding the absorbent core and overlapping at least a portion of the absorbent wrap, the absorbent wrap providing at least 20% of a total absorbent capacity of the absorbent structure.

2. The absorbent structure of claim 1, wherein the absorbent core comprises an air-formed absorbent material.

3. The absorbent structure of claim 1, wherein the absorbent core comprises an absorbent material selected from the group consisting of air-formed pulp fluff; a mixture of pulp fluff and superabsorbent; a mixture of pulp fluff and a polymer; a mixture of pulp fluff and hot melt spray adhesive; a mixture of pulp fluff and thermoplastic binder fibers; a mixture of pulp fluff, superabsorbent and binder fibers; coform; and combinations thereof.

4. The absorbent structure of claim 1, wherein the absorbent core comprises between 0% and about 10% by weight binder material.

5. The absorbent structure of claim 1, wherein the absorbent core comprises between 0% and about 15% by weight superabsorbent material.

6. The absorbent structure of claim 5, wherein the superabsorbent material is selected from the group consisting of particulates, fibers, films, foams, non-ionic superabsorbents, polyacrylate superabsorbents, and combinations thereof.

7. The absorbent structure of claim 1, wherein the absorbent wrap comprises at least 5% binder material.

8. The absorbent structure of claim 1, wherein the binder material is selected from the group consisting of meltblown polymer, thermoplastic binder fibers, liquid-sprayable binding agents, and combinations thereof.

9. The absorbent structure of claim 1, wherein the absorbent wrap comprises a coform material of a pulp and a meltblown polymer mixture.

10. The absorbent structure of claim 1, wherein the absorbent wrap provides at least 25% of a total absorbent capacity of the absorbent structure.

11. The absorbent structure of claim 1, wherein the absorbent wrap provides at least 30% of a total absorbent capacity of the absorbent structure.

12. The absorbent structure of claim 1, wherein the absorbent core is zoned for greater absorbent capacity within a central portion of the absorbent core and lower absorbent capacity within end regions of the absorbent core.

13. The absorbent structure of claim 1, wherein the absorbent core is segmented within the absorbent wrap.

14. The absorbent structure of claim 1, wherein the absorbent structure is embossed.

15. Swimwear comprising the absorbent structure of claim 1.

16. An absorbent structure, comprising:
an absorbent core including a mixture of superabsorbent material and meltblown fibers; and
an absorbent wrap including a binder material, the absorbent wrap fully surrounding the absorbent core and overlapping at least a portion of the absorbent wrap;
the absorbent structure having an absorbent wrap to inner core absorbency ratio of at least 0.2.

17. The absorbent structure of claim 16, wherein the mixture of superabsorbent material and meltblown fibers comprises a coform material.

18. The absorbent structure of claim 16, wherein the meltblown fibers comprise an elastomeric material.

19. The absorbent structure of claim 16, wherein the absorbent core further comprises pulp fluff.

20. The absorbent structure of claim 19, wherein the absorbent core comprises between about 30% and about 55% pulp fluff, by weight of the absorbent core.

21. The absorbent structure of claim 19, wherein the absorbent core comprises between about 35% and about 50% pulp fluff, by weight of the absorbent core.

22. The absorbent structure of claim 16, wherein the absorbent core further comprises a surfactant.

23. The absorbent structure of claim 16, wherein the absorbent core comprises between 0% and about 10% by weight binder material.

24. The absorbent structure of claim 16, wherein the absorbent core comprises up to about 15% by weight superabsorbent material.

25. The absorbent structure of claim 16, wherein the superabsorbent material is selected from the group consisting of particulates, fibers, films, foams, non-ionic superabsorbents, polyacrylate superabsorbents, and combinations thereof.

26. The absorbent structure of claim 16, wherein the absorbent wrap comprises at least 5% binder material.

27. The absorbent structure of claim 16, wherein the binder material is selected from the group consisting of meltblown polymer, thermoplastic binder fibers, liquid-sprayable binding agents, and combinations thereof.

28. The absorbent structure of claim 16, wherein the absorbent wrap comprises a coform material of a pulp and a meltblown polymer mixture.

29. The absorbent structure of claim 16, comprising an absorbent wrap to inner core absorbency ratio of at least 0.3.

30. The absorbent structure of claim 16, comprising an absorbent wrap to inner core absorbency ratio of at least 0.4.

31. The absorbent structure of claim 16, wherein the absorbent core is zoned for greater absorbent capacity within a central portion of the absorbent core and lower absorbent capacity within end regions of the absorbent core.

32. The absorbent structure of claim 16, wherein the absorbent core is segmented within the absorbent wrap.

33. The absorbent structure of claim 16, wherein the absorbent structure is embossed.

34. Swimwear comprising the absorbent structure of claim 16.

35. An absorbent swimwear garment, comprising:
a chassis defining a waist opening and first and second leg openings, the chassis including a body side liner, an outer cover, and an absorbent structure between the body side liner and the outer cover;
the absorbent structure including an absorbent core and an absorbent wrap, the absorbent wrap surrounding the absorbent core and overlapping at least a portion of the absorbent wrap, the absorbent wrap providing at least 20% of a total absorbent capacity of the absorbent structure.

36. The garment of claim 35, wherein the absorbent core comprises an air-formed absorbent material.

37. The garment of claim 35, wherein the absorbent core comprises an absorbent material selected from the group consisting of air-formed pulp fluff; a mixture of pulp fluff and superabsorbent; a mixture of pulp fluff and a polymer; a mixture of pulp fluff and hot melt spray adhesive; a mixture of pulp fluff and thermoplastic binder fibers; a mixture of pulp fluff, superabsorbent and binder fibers; coform; and combinations thereof.

38. The garment of claim 35, wherein the absorbent core comprises between 0% and about 10% by weight binder material.

39. The garment of claim 35, wherein the absorbent core comprises between 0% and about 15% by weight superabsorbent material.

40. The garment of claim 35, wherein the superabsorbent material is selected from the group consisting of particulates, fibers, films, foams, non-ionic superabsorbents, polyacrylate superabsorbents, and combinations thereof.

41. The garment of claim 35, wherein the absorbent wrap comprises at least 5% binder material.

42. The garment of claim 41, wherein the binder material is selected from the group consisting of meltblown polymer, thermoplastic binder fibers, liquid-sprayable binding agents, and combinations thereof.

43. The garment of claim 35, wherein the absorbent wrap comprises a coform material of a pulp and a meltblown polymer mixture.

44. The garment of claim 35, wherein the absorbent wrap provides at least 25% of a total absorbent capacity of the absorbent structure.

45. The garment of claim 35, wherein the absorbent wrap provides at least 30% of a total absorbent capacity of the absorbent structure.

46. The garmnent of claim 35, wherein the absorbent core is zoned for greater absorbent capacity within a central portion of the absorbent core and lower absorbent capacity within end regions of the absorbent core.

47. The garment of claim 35, wherein the absorbent core is segmented within the absorbent wrap.

48. The garment of claim 35, wherein the absorbent structure is embossed.
